(19) United States
(12) Patent Application Publication
(10) Pub. No.: US 2017/0146476 A1
(43) Pub. Date: May 25, 2017

(54) Fluid Probe

(71) Applicants: William Lawrence Priest, West Hartford, CT (US); Satish Kumar, East Lyme, CT (US)

(72) Inventors: William Lawrence Priest, West Hartford, CT (US); Satish Kumar, East Lyme, CT (US)

(73) Assignee: IDM Engineering, LLC, West Hartford, CT (US)

(21) Appl. No.: 14/951,867

(22) Filed: Nov. 25, 2015

(51) Int. Cl. G01N 27/22

(52) U.S. Cl. CPC G01N 27/226

(57) ABSTRACT

The present invention is generally related to a multi-purpose, low cost, submersible fluid probe. The probe is comprised of a housing, a printed circuit board (PCB), and an electrical cable. The housing is a threaded machined fitting that supports the PCB and includes a port to allow the electrical cable to connect to the PCB. The PCB includes dual traces formed in a planar rectangular spiral pattern. The electrical cable includes jacketed conductors and an integral connector that allows the probe to be connected to various control circuits and used for multiple purposes.

### BACKGROUND OF THE INVENTION

The present invention relates generally to submersible fluid probes and more specifically to fluid probes that include electrodes used to detect the electrical properties of the fluid they are submersed in. Numerous probes are commonly used that include these general characteristics and are used with many fluids and in many applications. In most applications, the probes are integral to the system and generally can not be replaced. Due to the nature of the fluids they are in contact with, this leads to considerable expense when the probes can no longer fulfill their intended purpose due to corrosion, contamination, or wear. In many applications to obtain the sensitivity required from the probe, significant machining, manufacturing, and material costs are required to meet the operational and performance requirements necessary for their intended purpose. The present invention addresses those issues in a device that is easy to manufacture, can be built to very stringent tolerances with quality materials, and most importantly at relatively low costs.

### SUMMARY OF THE INVENTION

The present invention relates to a multi-purpose, low cost, submersible fluid probe. In one embodiment the invention includes a housing, a printed circuit board (PCB), a protective tube, electronic potting compound, and an electrical cable assembly. The housing is a machined metal fitting that supports the PCB and protective tube. It includes an opening to allow the electrical cable to connect to the PCB and is threaded to allow the probe to be secured into the port of piece of equipment that will allow it to come into contact with a fluid. The PCB includes dual traces formed in a planar rectangular spiral pattern. This configuration maximizes the length of the electrodes and tightly controls their size and spacing. The PCB also includes provisions for mounting a cable assembly and a thermistor. Finally, it includes gold plating on the traces to protect them from corroding and to increase the sensitivity of the probe. The protective tube encloses the PCB to protect it from coming into direct contact with the equipment and shorting the electrodes. It is made of a non-conductive polymer and includes apertures to allow the fluid to flow over the surface of the PCB. A multi-conductor cable is attached to the PCB and exits the housing through a sealed port. It is terminated in a sealed connector that allows the probe to be connected to an electronic module. Epoxy based potting compound is use to secure and seal the housing, PCB, tube and cable together into a single component. This configuration is not only very sensitive with respect to the electrical properties of a fluid, it is also relatively easy to manufacture and low cost.

In another embodiment of the present invention, the PCB includes traces of the planar rectangular spiral on both sides of the printed circuit board.

In another embodiment of the present invention, the housing includes an integral connector replacing the cable assembly.

Many additional variations are possible within the present invention and advantages will become apparent in the following detailed description.

### DESCRIPTION OF THE DRAWINGS

A better understanding of the operation of the probe may be obtained by referencing the following drawings in conjunction with the detailed descriptions of the invention:

FIG. 1: is a perspective view of the probe in accordance with an embodiment of the present invention

FIG. 2: is a schematic of the probe illustrating a system in accordance with an embodiment of the present invention

FIG. 3: is a partial view of the probe in accordance with an embodiment of the present invention

FIG. 4: is a partial view of the probe in accordance with an embodiment of the present invention

### DETAILED DESCRIPTION OF THE INVENTION

A multi-purpose, low cost, submersible fluid probe provides several advantages for maintaining industrial fluids 20, such as lubricating oil, hydraulic fluid, and the like. It can be used with capacitance and impedance based control systems to sense the presence of various fluids and/or the properties of the fluid it is immersed in. It can be used as a level sensor to detect various volumes in fluid storage tanks, it can be used to detect changes in electrical properties in real time, and it can be used to record changes over extended periods of time just to name a few of it potential applications. It is also an easy to manufacture, low cost device that can be utilized in applications that could normally not justify its use due to cost constraints. The following description provides a unique solution for such a device.

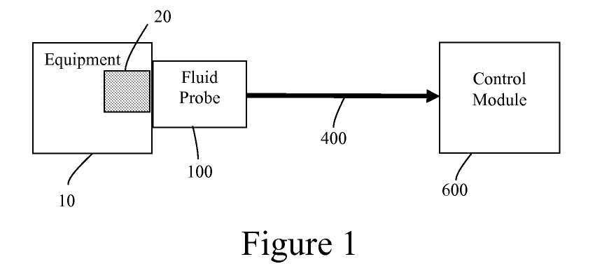

FIG. 1 is a simple schematic depicting how such a device would interact with a piece of equipment 10. The equipment 10 would include a port(s) that would allow the fluid probe(s) 100 to be attached and to be exposed to a fluid. The fluid probe 100 would connect to a control module 600 by means of an electrical cable assembly 400. The control module 600 would be an impedance or capacitance based circuit designed for a specific purpose based on its intended function.

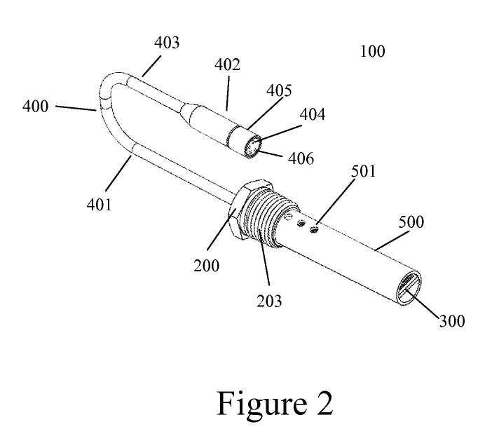

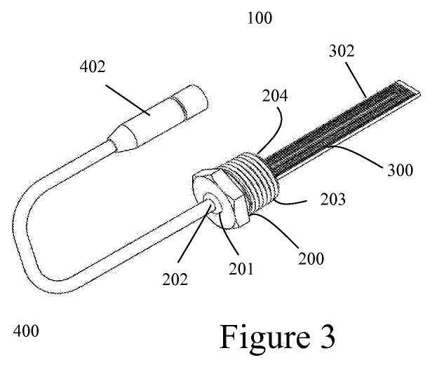

In the preferred embodiment the fluid probe 100 (as shown in FIGS. 2 and 3) includes a housing 200, a printed circuit board (PCB) 300, an electrical cable assembly 400, and a protective tube 500.

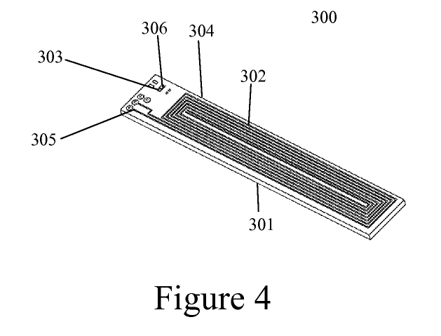

The PCB as shown in FIG. 4 consists of a rigid substrate, dual copper traces, and a surface mount temperature sensor. The substrate is formed by laminating synthetic materials impervious to industrial fluids using standard manufacturing processes and includes copper conductors on the surface.

The conductors form dual parallel traces in the shape of planar rectangular spirals. In the preferred embodiment, the traces are gold plated, are duplicated on the opposite side of the PCB, and conductively connected by plated thru holes. The copper traces also include pads for installing a surface mount temperature sensor. In the preferred embodiment, the temperature sensor is a thermistor selected based on the required operating temperatures of the probe. Additional plated thru holes are included to connect multiple conductors from a cable assembly to the PCB to transmit signals from the traces to a control circuit.

The cable assembly consists of multiple conductors and an integral connector. The conductors are copper wires sized for the electrical load of the control circuit and jacketed with an insulator to protect the conductor. The conductors are bundled within a secondary jacket to provide additional environmental and physical protection from weather and mechanical contact. The wires are stripped at one end to allow them to be soldered to the PCB in a specific arrangement. At the opposite end, the wires are terminated by metal terminals and inserted into an integral electrical connector. The connector is made from thermoset plastic and is molded onto the conductor bundle. The connector includes a threaded fitting that mates with an opposing connector and a seal to prevent water from entering the terminal interface of a pair of connectors.

In the preferred embodiment, the PCB seats in a machined metal housing. The metal housing includes an aperture that allows the cable assembly to exit the housing. An elastomeric grommet is place on the cable assembly to protect it from the edges of the aperture. The housing includes an external thread that is sized to interface with a mating thread of a port from a piece of equipment.

A protective tube also seats in the housing to support the PCB, to protect it from contacting the piece of equipment directly, and to allow fluid to flow past the PCB. The protective tube is manufactured from a non-conductive thermoplastic that is compatible with industrial fluids, in the preferred embodiment the tube is PTFE. The tube includes multiple ports to allow fluid to flow past the probe and contact the traces of the PCB.

Finally, the PCB and tube are bonded to the housing with an epoxy based electronics potting compound. The PCB and tube are submersed in potting compound with sufficient material to encapsulate the end of the PCB, the tube, the cable assembly conductors, and the heat sensor. The planar rectangular spiral traces remain uncovered to allow them to contact a fluid.

In summary the fluid probe 100 as described herein not only provides an effective means for monitoring the electrical properties of a fluid within a piece of equipment 10, but it does so in a form that is easy to manufacture and is low cost. The foregoing description of a preferred embodiment of the invention has been presented for purposes of illustration and description. It is not intended to limit the invention to the precise form disclosed. The preferred embodiment was chosen and described in order to best illustrate the principles of the invention and its practical application to enable one of ordinary skill in the art to best utilize the invention in various embodiments and with various modifications. It is intended that the scope of the invention be defined by the following claims.

1. A submersible fluid probe used to monitor the electrical properties of a fluid comprising
a housing
a printed circuit board (PCB)
a protective tube
electronic potting compound
an electrical cable assembly

2. The device of claim 1, wherein the housing includes external threads for mounting to a piece of equipment

3. The device of claim 1, wherein the housing is formed from steel, aluminum, brass, or plastic

4. The device of claim 1, wherein the traces on the PCB are formed in a parallel planar rectangular spiral pattern

5. The device of claim 1, wherein the traces on the PCB are duplicated on both sides of the PCB

6. The device of claim 1, wherein the traces are gold plated

7. The device of claim 1, wherein the PCB includes a heat sensor

8. A submersible fluid probe used to monitor the electrical properties of a fluid comprising
a housing with an integral connector
a printed circuit board (PCB)
a protective tube
electronic potting compound

9. A method for maintaining a piece of equipment wherein, the fluid probe of claim 1 will be used to measure fluid properties

10. A method for maintaining a piece of equipment wherein, the fluid probe will be used to detect fluids
